(19) United States
(12) Patent Application Publication
(10) Pub. No.: US 2020/0281239 A1
(43) Pub. Date: Sep. 10, 2020

(54) PREPARATION OF READY TO EAT QUINOA FLAKES

(71) Applicant: M/S.CERIO EXPORTS PRIVATE LIMITED, Ameerpet, Hyderabad (IN)

(72) Inventor: Kalyan SURAPANENI, Hyderabad (IN)

(73) Assignee: M/S.CERIO EXPORTS PRIVATE LIMITED, Ameerpet, Hyderabad (IN)

(21) Appl. No.: 16/644,877

(22) PCT Filed: Sep. 4, 2018
(86) PCT No.: PCT/IN2018/050568

§ 371 Date: Mar. 5, 2020

(30) Foreign Application Priority Data
Sep. 6, 2017 (IN) 201741031500

(51) Int. Cl. A23L 25/00; A23L 5/10; A23L 29/30; A23L 27/00; A23L 33/115

(52) U.S. Cl. CPC A23L 25/30; A23L 25/25; A23L 5/15; A23V 2002/00; A23L 27/88; A23L 33/115; A23L 5/13; A23L 29/30

(57) ABSTRACT

An instant food composition containing flaked quinoa seeds and a method of preparation of ready to eat food composition containing quinoa seeds. The method of preparation of instant food composition containing flaked quinoa seeds includes soaking the quinoa seeds in a hot liquid at its boiling temperature for a predetermined temperature, drying the boiled quinoa seeds at room temperature for a predetermined period, roasting the dried quinoa seeds for a predetermined period, flattening of quinoa seeds to form flakes, drying of quinoa flakes for a predetermined period, coating of quinoa flakes with edible oil, coating of quinoa flakes with edible starch on edible oil coated quinoa flakes within predetermined period, coating of quinoa flakes with edible oil on the starch Coated quinoa flakes.

### FIELD

Aspects of the disclosed embodiments relate to an instant food composition and more specifically relate an instant food composition containing quinoa flakes and a method of making the instant food composition containing quinoa flakes.

### BACKGROUND

Quinoa is a flowering plant in the amaranth family Amaranthaceae. It is a pseudocereal rather than a true cereal. Quinoa is closely related to the edible plants beetroot, spinach, and amaranth (Amaranthus spp.), another pseudocereal which it closely resembles. After harvest, the seeds are processed to remove the outer coating that contains bitter-tasting saponins. The seeds are cooked the same way as rice and can be used in a wide range of dishes.

When cooked, the nutrient composition is comparable to common cereals like wheat and rice, supplying a moderate amount of dietary fiber and minerals. Quinoa has small seeds or fruit similar to that of millet. After harvesting, quinoa is washed and dried. In particular, quinoa is rich in proteins, which contain all the essential amino acids in balanced proportions. It also has a good composition of mineral salts and vitamins.

Quinoa was used to be seen as a peasant food that provided farming families with a very important source of nutrition, but presently, it is used by many as their everyday food in instant and ready to eat form. Several such instant quinoa preparations have flooded the market but as and when they are mixed with hot water/milk, the quinoa mix due to its soft texture becomes a homogeneous mixture of semi-solid liquid form and gets dissolved in water/milk, thereby making the consumption of dissolved composition in the preparation difficult.

U.S. Pat. No. 7,563,473 titled “Quinoa protein concentrate, production and functionality” discloses a quinoa protein concentrate that can be used as a food ingredient. However, the quinoa protein concentrate disclosed cannot be consumed directly as food.

CA2968346 patent titled “Procedure for obtaining instantaneous quinoa” discloses a method for the production of instant quinoa flour, comprising the cooking and grinding of the quinoa and a subsequent enzymatic treatment with amylases and proteases. However, it is a consumable as a homogenous mixture and susceptible to lumps formation and also difficult to consume it.

US20130071524 patent titled “Coated food product and methods” discloses a method for coating ready to eat cereal by applying a slurry coating containing sucrose to the cereal base. However, the texture of the ready-to-eat cereal is not firm enough upon addition of water/milk.

The instant quinoa flakes available in the market become pasty and unsuitable to consume immediately after adding water/milk. Apart from the quality of the quinoa flakes, considerable amount of time has to spent on cooking of quinoa flakes.

Hence, none of the prior art references have disclosed any specific quinoa composition and method of preparation of the same having insoluble properties, when mixed with milk or water.

Therefore, there remains a need for quinoa flakes that are easily and swiftly prepared, retaining good nutritive value and doesn't become a homogenous pasty mixture i.e. insoluble with the added milk or water.

### Object

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

It is an object of the aspects of the disclosed embodiments to provide instant food composition containing quinoa flakes for easy preparation.

It is an object of the aspects of the disclosed embodiments to provide instant food composition containing quinoa flakes which is ready to eat within 60 seconds.

It is an object of the aspects of the disclosed embodiments to provide instant food composition which retains its texture, when mixed with milk or water and enabling the mixture consumable without formation of any lumps.

### BRIEF DESCRIPTION OF THE DRAWINGS

Other objects and advantages of the present disclosure will become apparent to those skilled in the art upon reading the following detailed description of the preferred embodiments, in conjunction with the accompanying drawings, wherein like reference numerals have been used to designate like elements, and wherein:

FIG. 1 is a flowchart depicting steps for manufacturing of instant food composition containing quinoa.

### DESCRIPTION

It is to be understood that the present disclosure is not limited in its application to the details of composition set forth in the following description. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and the like, herein do not denote any order, quantity, or importance, but rather are used to distinguish one element from another.

Reference throughout this specification to “one embodiment,” or similar language means that a particular feature, structure, or characteristic described in connection with the embodiment is included in at least one embodiment of the present invention. Thus, appearances of the phrases “one embodiment,” and similar language throughout this specification may, but do not necessarily, all refer to the same embodiment, different embodiments, or component parts of the same or different illustrated invention.

Each statement of an embodiment is to be considered independent of any other statement of an embodiment despite any use of similar or identical language characterizing each embodiment.

The wording “one embodiment,” or the like, does not appear at the beginning of every sentence in the specification, is merely a convenience for the reader's clarity. However, it is the intention of this application to incorporate by reference the phrasing “an embodiment,” and the like, at the beginning of every sentence herein where logically possible and appropriate.

The words “instant food” or ready to eat food or ready to eat means any food product that is ready to be consumed. Instant foods are the foods that provide convenience to consumers and assists in reducing the time of preparation or time of cooking.

The word “pseudocereal” or the like means plants that produce fruits or seeds which are used and consumed as grains, though botanically pseudocereals are neither grasses nor true cereal grains. Pseudocereals are typically high in protein and other nutrients, gluten-free, and are considered whole grains. Examples of pseudocereal include but not limited to quinoa, amaranth, buckwheat, chia, wattleseed, kaniwa.

It is an object of the present disclosure to provide an instant food composition containing quinoa flakes with reduced cooking time, enhanced appearance and also a method for preparing the food composition. The instant food composition obtained by the present invention has firm texture, very good structural integrity and very good consumer appeal. The present instant food composition containing quinoa flakes gets cooked just by adding hot water or hot milk within 60 seconds.

In one embodiment of the present disclosure, the method of preparation of ready to eat pseudocereal includes soaking the pseudocereal in a hot liquid at its boiling temperature for a predetermined temperature, drying the boiled pseudocereal at room temperature for a predetermined period, roasting the dried pseudocereal for a predetermined period, flattening of pseudocereal seeds to form flakes, drying of pseudocereal flakes for a predetermined period, coating of pseudocereal flakes with edible oil, coating of pseudocereal flakes with edible starch on edible oil coated pseudocereal flakes within predetermined period, coating of pseudocereal flakes with edible oil on the starch coated pseudocereal flakes. The method of preparation also includes coating of pseudocereal flakes with a flavouring agent. The method further includes adding of vegetables, fruits, nuts, spices, herbs, colours. Examples of pseudocereal include but not limited to quinoa, amaranth, buckwheat, chia, wattleseed, kaniwa.

In one embodiment of the present disclosure, the instant food composition containing quinoa flakes are coated multiple edible coating agents in multiple stages. In one embodiment of the present invention, the quinoa flakes are coated in two stages. In the first stage, the quinoa flakes are coated with edible oil and in the second stage, the quinoa flakes are coated with starch. Coating with oil helps in sticking of starch to the flakes. Coating with starch helps in retaining firm texture of the quinoa flakes when cooked with water or milk.

In one embodiment of the present disclosure, coating of oil to the flakes is done by using pressurized gun. Uniform coating of oil to the flakes can be also be done by any spraying device. In one embodiment of the invention, the excess oil on the flakes is removed during drying of the quinoa flakes.

The present instant food composition containing quinoa seeds may also include vegetables, fruits, nuts, spices, herbs, colours and flavours. The vegetables may include carrots, peas, beans, tomatoes etc. The fruits may include banana, cherry, raisins. The nuts include cashew, pistachio, almonds, raisins etc. The spices may include cinnamon, pepper, coriander and garlic. The herbs may include tulasi, oregano, mint, basil etc. The colours and flavours used in the present invention are edible grade and may be either natural or artificial in nature. The vegetables, fruits, nuts, spices, herbs may be cut into small pieces before adding to the quinoa flakes. Inclusion of vegetables, fruits, nuts, spices, herbs, colours and flavours are intended to make the instant food composition containing quinoa flakes nutritional and appealing to the consumer. Additionally, the instant food composition containing quinoa flakes may include, vitamins, minerals, salts to further enhance the nutritive value. In one embodiment of the invention, the mixing of quinoa flakes and other ingredients is done in a vessel and stirred for uniform mixing.

In one embodiment of the present disclosure, hot water or hot milk is added to the instant food composition containing quinoa flakes to make it as ready-to-serve food. Addition of hot water or hot milk aids in cooking of the food composition containing quinoa flakes instantly, preferably within 60 seconds. The texture of the quinoa flakes remains firm even after cooking and thus making the cooked food appealing to the consumer. The coating of the quinoa flakes with oil and starch helps in preventing the formation of lumps after cooking.

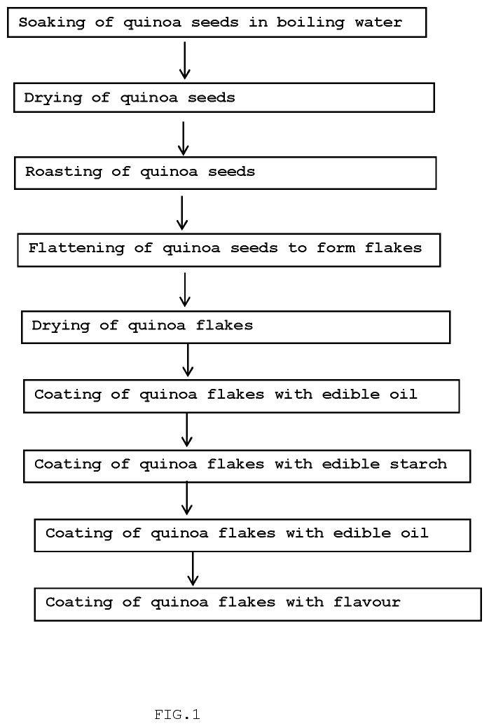

A flowchart for a method of preparing the instant food composition containing quinoa flakes is depicted in FIG. 1. As illustrated in FIG. 1, the instant food composition containing quinoa includes the following steps:—(i) Soaking of quinoa seeds in boiling water, (ii) drying of quinoa seeds, (iii) roasting of quinoa seeds, (iv) flattening of quinoa seeds to form flakes, (v) drying of quinoa flakes, (vi) coating of quinoa flakes with edible oil, (vii) coating of quinoa flakes with edible starch, (viii) coating of quinoa flakes with edible oil, (ix) coating of quinoa flakes with flavour.

In one embodiment of the present disclosure, the quinoa seeds are soaked in a vessel containing boiling water. The temperature of the water ranges from 95° C. The quinoa seeds are soaked in boiling water for a duration of 5 min and then the water is drained off. Soaking of quinoa seeds in boiling water alters the enzymatic activity in the dehulled quinoa seeds, plasticizes the quinoa seeds for flaking and is essential for the instant cooking of quinoa flakes under 1 minute upon adding hot water/milk.

In one embodiment of the present disclosure, the soaked quinoa seeds are dried under ambient air temperatures for 10-12 mins and then subjected to dry roasting by a roasted at 95° C. for a time of 45 mins. Roasting of quinoa seeds is done to improve the crunchy texture, taste and extrudability of the quinoa flakes.

In one embodiment of the present disclosure, the quinoa seeds are passed through the rollers to form quinoa flakes. In one embodiment of the invention, the dehulled quinoa seeds are heat treated before passing them through the rollers. In one embodiment of the invention, the rollers used for flaking quinoa seeds are customized such that the size of quinoa flakes obtained is optimum. The gap between the rollers is maintained so as to be equal to lowest size of the quinoa grain present in the production batch. Average size and thickness of the quinoa flakes depends on the size of quinoa grains being used.

In one embodiment of the present disclosure, the quinoa flakes are subjected to coating by any human consumable edible oil which may be selected from groundnut oil, sun flower oil, soybean oil, palm oil, cotton seed oil or any other edible oil known in the art. Saturated oils like palm oil and coconut oil are preferred than unsaturated oils because they prevent rancidity and increase shelf life of the flakes. In one embodiment of the invention, the edible oil may be blended oil containing one or more aforementioned edible oils. The edible oil is applied as a coating to the quinoa flakes by a pressurized hand sprayer while the flakes are rotating in a coating pan. The edible oil may also be applied as a coating by any spraying device known in the art. Coating of the quinoa flakes with edible oil improves sticking of the starch to the quinoa flakes. The quantity of oil used for coating of quinoa flakes ranges from 50 ml to 55 ml per Kg of quinoa flakes. In one embodiment of the invention, the excess oil present on the flakes is removed by drying in tray driers.

In one embodiment of the present disclosure, the flakes obtained are subjected to starch coating. The starch used for coating of quinoa flakes may be selected from corn starch, tapioca starch or any other edible starch. In one embodiment of the invention, the edible starch may be blended starch containing one or more aforementioned edible starches. The edible starch is applied as a coating by using pressurized hand sprayer while the flakes are rotating in a coating pan. The coating of quinoa flakes makes the quinoa flakes water insoluble and serves the purpose of giving a desirable texture when the coated cereals are added to water. In one embodiment of the invention, coating of pseudocereal flakes with edible starch is done within 10 seconds after coating of pseudocereal flakes with edible oil so that edible starch sticks to the quinoa flakes in an effective way.

In one embodiment of the present disclosure, there are two levels of oil spraying 15 by the pressurized oil sprayer. In one embodiment of the invention, the first level of oil spraying of 50-55 ml of palm oil per kg of flakes is done so that the starch to adhere to the flakes. In one embodiment of the invention, after the starch coating is done, one additional coating of edible oil at the rate of 50-55 ml per kg of starch coated flakes. In one embodiment of the present disclosure, the quinoa flakes are coated with a flavour after coating of quinoa flakes with oil and starch. Coating of quinoa flakes with flavours enhances the consumer appeal.

In one embodiment of the present disclosure, spraying of oil onto the quinoa flakes and then spraying of starch onto the flakes helps in retaining texture upon adding water or milk. In a preferred embodiment, oil is used as a first layer of coating and starch as second layer of coating.

The end result of the aforementioned method is an instant food composition containing quinoa flakes which cooks under 60 seconds upon addition of hot water or hot milk. The aforementioned quinoa flakes also maintain the texture and do not dissolve in hot water thereby providing a good consumer appeal. Therefore mentioned quinoa flakes obtained after addition of hot water or hot milk is free from formation of lumps.

In one embodiment of the present disclosure the instant food composition containing quinoa flakes has a moisture content of about 6% to 7%. Therefore mentioned instant food composition containing quinoa flakes has very good storage life when stored under ambient conditions.

In one embodiment of the present disclosure, the method of preparing instant food composition containing quinoa flakes provides good yield and is economically feasible. In one embodiment of the invention using the aforementioned method, the output yield ranges from 75% to 85%.

While specific embodiments of the present disclosure have been shown and described in detail to illustrate the inventive principles, it will be understood that the present disclosure may be embodied otherwise without departing from such principles.

1-9. (canceled)

10. A method of preparation of ready to eat pseudocereal, the method comprising:
a. soaking the pseudocereal for a period of 10 minutes in a hot liquid maintained at temperature of 95 degrees celcius;
b. drying the boiled pseudocereal at room temperature for a period of 12 minutes;
c. roasting the dried pseudocereal for a period of 45 minutes;
d. flattening of pseudocereal seeds to form flakes;
e. drying of pseudocereal flakes for a period of 12 minutes;
f. coating of pseudocereal flakes with edible oil;
g. coating of pseudocereal flakes with edible starch on edible oil coated pseudocereal flakes within a period of 10 Seconds;
h. coating of starched pseudocereal flakes with a flavoring agent.

11. The method of preparation of ready to eat pseudocereal as claimed in claim 10, wherein the exemplary pseudocereal seeds are selected from the group consisting of quinoa, amaranth, buckwheat, chia, wattle seed, kaniwa and the like.

12. The method of preparation of ready to eat pseudocereal as claimed in claim 10, wherein edible oil exemplifies groundnut oil, sun flower oil, soybean oil, palm oil, cotton seed oil or any other edible oil.
